(19) United States
(12) Patent Application Publication
(10) Pub. No.: US 2009/0115195 A1
(43) Pub. Date: May 7, 2009

(54) Gravity Power Generation Mechanism

(76) Inventors: Chun-Chao WANG, Kaohsiung City (TW); Yuh-Suiang Wang, Kaohsiung City (TW)

Correspondence Address: Dr. BANGER SHIA, 102 Lindencrest Ct., Sugar Land, TX, 77479-5201, US

(21) Appl. No.: 11/935,228

(22) Filed: Nov. 5, 2007

(51) Int. Cl. F03G 3/08

(52) U.S. Cl. 290/1 R; 185/27

(57) ABSTRACT

A gravity power generation mechanism utilizes a gravity energy conversion unit to convert the gravity potential energy into the kinetic energy. The gravity energy conversion unit produces positive torques by adopting outward-spreading single directional swing arms and reduces the negative torques by cooperating with the folding action of the single directional swing arms, so as to perform a long-time, effective and continuous energy conversion of converting gravity potential energy into the kinetic energy. Next, the kinetic energy will be transmitted to a power generating unit to perform another energy conversion of converting the kinetic energy into the electric energy. And finally, a power supply system is used to transmit the electric energy out. By such arrangements, the gravity power generation mechanism not only has the advantages, such as: more simplified in structure, higher conversion ratio, and more environment-friendly but only needs a little of starting energy to perform a long-time energy conversion.

### BACKGROUND OF THE INVENTION

1. Field of the Invention

The present invention relates to a power generation mechanism, and more particularly to a gravity power generation mechanism which has the advantages such as: more simplified in structure, higher energy conversion ratio, and more environment-friendly and only needs a little of starting energy to perform a long-time energy output.

2. Description of the Prior Art

Recently, the energy source which can adequately produce energy is insufficient, and this has become an urgent problem to be solved for every country. The energy can be produced by various energy sources, such as thermal energy, light energy, wind energy. The problems of several common energy sources are respectively described as below.

The most common energy source is the fossil fuel (such as crude oil, natural gas and coal). The fossil fuel generally produces high thermal energy or explosion energy through combustion for enabling the engine to use the explosion energy to move the motorcar or utilize the steam to impulse the turbine to generate electricity. However, the burning of fossil fuel will cause the air pollution and the global greenhouse effect. In addition, due to the high consumption of the fossil fuel, the amount of fossil fuel in the earth's crust is decreasing rapidly. As a result, the source of the fossil fuel is becoming less and less, and the price increasingly rises, and it will be used up in the near future.

Another energy source is the nuclear energy. Though the nuclear energy is always available for use by nuclear fission and nuclear fusion, the safety of the nuclear power plant is still controversial. It is important that, how to correctly treat the nuclear waste material has become a puzzled problem for human beings. The storage and the accumulation of the waste material are both costly and difficult to perform.

Other energy sources, such as solar energy, wind energy and tidal energy, are the non-pollution energy sources which the modern people seek for, but they are the natural energy which the human beings cannot assuredly control. Solar energy, wind energy and tidal energy change greatly with the weather and season and thus cannot be supplied stably.

The present invention has arisen to mitigate and/or obviate the afore-described disadvantages.

### SUMMARY OF THE INVENTION

The primary objective of the present invention is to provide gravity power generation mechanism which can provide a continuous and stable operation to continuously convert the gravity potential energy into the kinetic energy and then to convert the kinetic energy into the electric energy, so as to perform a long-time, effective and stable energy output.

The present invention utilizes a gravity energy conversion unit to convert the gravity potential energy into the kinetic energy. The gravity energy conversion unit produces positive torques by adopting outward-spreading single directional swing arms and reduces the negative torques by cooperating with the folding action of the single directional swing arms, so as to perform a long-time, effective and continuous energy conversion of converting gravity potential energy into the kinetic energy. Next, the kinetic energy will be transmitted to a power generating unit to perform another energy conversion of converting the kinetic energy into the electric energy. And finally, a power supply system is used to transmit the electric energy out.

By such arrangements, the gravity power generation mechanism not only has the advantages, such as: more simplified in structure, higher conversion ratio, and more environment-friendly but only needs a little of starting energy to perform a long-time energy conversion. More particularly, the gravity is more stable, so the present invention is more stable than the wind power generation and the solar power generation systems and can be placed at an arbitrary position without being affected by the outside environment.

The secondary objective of the present invention is to provide a gravity power generation mechanism which not only can independently generate electricity but can be parallel connected to the wind power and the solar power generation systems to generate electricity.

The gravity power generation mechanism of the present invention utilizes a gravity energy conversion unit to convert the gravity potential energy into the kinetic energy, performing a long-time, effective and stable energy output. The gravity power generation mechanism of the present invention not only can independently generate electricity but can be parallel connected to the wind power and the solar power generation systems to generate electricity. By such arrangements, after the motor is started to provide the gravity power generation mechanism a little of starting energy, the gravity power generation mechanism can self-output the energy for a long time.

The gravity energy conversion unit includes at least one wheel member, at least one transmitting member and a plurality of single directional swing arms. The wheel members and the transmitting member are disposed along the direction of gravity, and the wheel members and the transmitting member are drivingly connected to each other. The single directional swing arms utilize the single directional pivot seats to be equidistantly positioned outside the transmitting member. The single directional pivot seats only allow the respective single directional swing arms to rotate in opposite direction of the transmitting member. By such arrangements, the respective single directional swing arms which only cast towards one side will produce larger torques. On the other hand, the single directional swing arms rising at the other side of the transmitting member are just located within the negative pivot rotational angle, so the single directional swing arms at the other side of the of the transmitting member are folded on the surface of the transmitting member to form a smaller negative torque.

The single directional pivot seats only allow the respective single directional swing arms to be pivotally folded 90 degrees in opposite direction of the transmitting member, and the respective single directional swing arms can freely rotate within a horizontal and vertical angle with respect to the transmitting member.

The configuration path of the wheel members and the transmitting member of the gravity energy conversion unit can be similar to the round shape, the elliptic shape, rectangular shape, the triangular shape, and the polygonal shape. The configuration paths all adopt the design of converting the gravity potential energy into the kinetic energy correspondingly to the direction of gravity.

The transmitting member and the wheel members of the gravity energy conversion unit can be designed as: a cooperation of a chain and chain wheels, a cooperation of a belt and pulleys or a cooperation of a wheel rail belt and driving delivery wheels.

Each single directional swing arm includes at least one swing rod and a pivot rod. An outer end of the swing rod is fixed with a gravity member, and the other end of the swing rod utilizes an axial elongated pivot hole thereof to restrict a pivot pin of the pivot rod and to allow a certain distance inertial extension between the swing rod and the pivot rod. Due to the design of the single directional swing arms, the gravity member at the outer end of the swing rod will produce a larger positive torque, and the inertial extension between the swing rod and the pivot rod will produce a larger positive torque.

The gravity energy conversion unit can be parallel connected to multiple gravity energy conversion units to produce a much larger positive torque for driving a power generating unit with much more capacity. The power generating unit can be parallel connected to at least one mechanical structure to increase the positive torque which the power generation requires.

### BRIEF DESCRIPTION OF THE DRAWINGS

FIG. 1 is a schematic view of a gravity power generation mechanism in accordance with a first embodiment of the present invention;

FIG. 2 is a schematic view illustrating the gravity energy conversion in accordance with a second embodiment of the present invention;

FIG. 3 is an operational view of the gravity power generation mechanism in accordance with the second embodiment of the present invention;

FIG. 4 is an operational view of a gravity power generation mechanism in accordance with a third embodiment of the present invention;

FIG. 5 is a schematic view of a round configuration path in accordance with the present invention; and

FIG. 6 is a schematic view of a rectangular configuration path in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

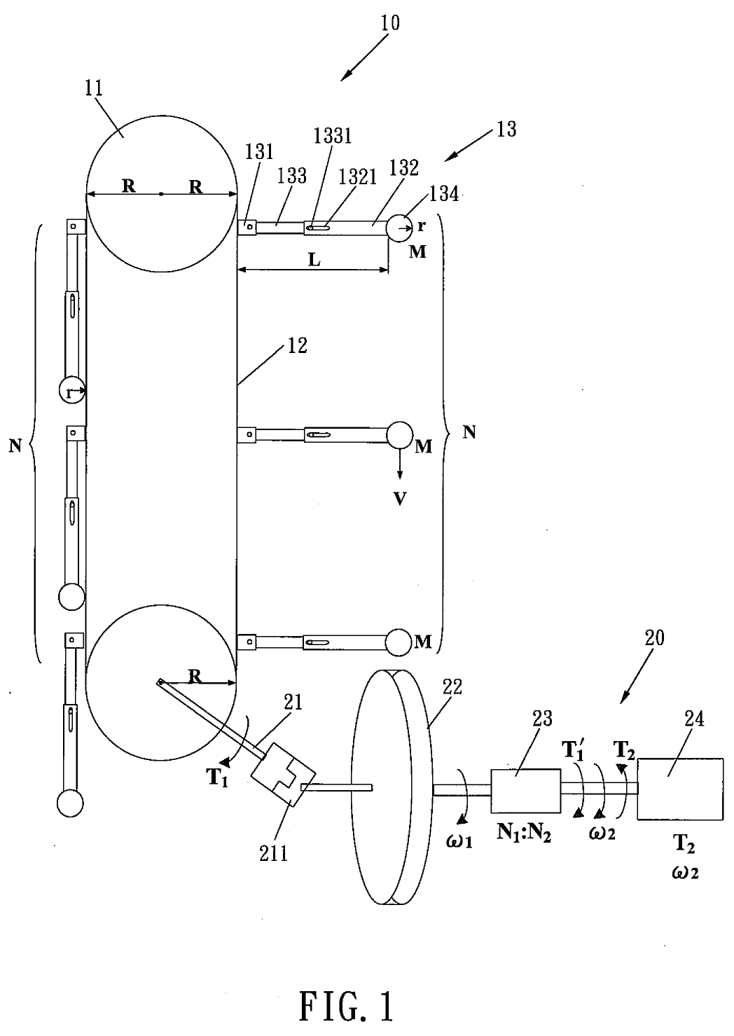

FIG. 1 shows a gravity power generation mechanism in accordance with a parallel running embodiment of the present invention, but the present invention doesn't limit the parallel running implementation in FIG. 1 to be the only implementation mode.

The gravity power generation mechanism in accordance with the first embodiment of the present invention comprises a gravity energy conversion unit 10 and at least one power generating unit 20, and is characterized in that:

The gravity energy convention unit 10 includes two wheel members 11, a transmitting member 12 and a plurality of swing arms 13, which is pivotally coupled with at least two wheel members 11. The transmitting member 12 is mounted on the two wheel members 11, and the transmitting member 12 is drivingly connected with the two wheel members 11. These single directional swing arms 13 are equidistantly positioned outside the transmitting member 12 by the single directional pivot seats 131. The single directional pivot seats 131 only allow the respective swing arms 13 to pivotally rotate in opposite direction of the transmitting member 12 (such as the negative allowable free angle is vertical 90 degrees). The single swing arm 13 includes at least one swing rod 132 and a pivot rod 133 that are pivotally coupled to each other. An outer end of the swing rod 132 is fixed with a round gravity member 134. The other end of the swing rod 132 uses an axial elongated pivot hole 1321 thereof to restrict a pivot pin 1331 of the pivot rod 133.

The design of the transmitting member 12 and the wheel members 11 causes the circular running in the direction of gravity. The transmitting member 12 and the wheel members 11 can take the form of chain wheels and chain or can also take the form of belt and pulleys. In addition, they can also be the driving delivery wheels and the wheel rail belt.

The power-generating unit 20 includes a connecting shaft 21, a fly wheel 22, a gear box 23, and a generator 24. The connecting shaft 21 is installed with a universal joint 211. One end of the connecting shaft 21 is connected with the wheel member 11 of the gravity energy conversion unit 10. The connecting shaft 21 is driven by the wheel member 11, and the connecting shaft 21 transmits the rotational kinetic energy to the generator 24 through the fly wheel 22 and the gear box 23. At this moment, the generator 24 starts to rotate to generate electricity. And finally, the power generating unit 20 will transmit out the electric energy. The aforementioned is the characters of the structure and the features of the configuration of the present invention.

It is important that, when one arbitrary swing arm 13 of the gravity energy conversion unit of the gravity power generation mechanism casts with the center of gravity, since the single pivot seats 131 only allow the respective single directional swing arm 13 to pivotally rotate 90 degrees in opposite direction of the transmitting member 12, the respective single directional swing arm 13 which is cast towards one side will produce larger positive torque. The gravity member 134 at the outer end of the swing rod 132 will combine with the larger torque to generate the larger positive energy. The inertial extension between the swing rod 132 and the pivot rod 133 will also enhance the positive energy. On the other hand, the single directional swing arms 13 parallel rising at the other side of the transmitting member 12 are just within the opposite pivot rotational angle of the single directional pivot seats 131, so the other side single directional swing arms 13 will pivotally rotate to be folded on the surface of the transmitting member 12, forming a smaller negative torque and a negative resistance.

Hence, after the first single swing arm 13 with the center of gravity is cast, the two wheel members 11 together with the transmitting member 12 of the gravity energy conversion unit 10 act in positive direction (the direction in which the swing arm 13 with the center of gravity is cast). At this moment, the single directional arms 13 which are equidistantly arranged outside the transmitting member 12 will be continuously cast. The precise calculation of the smaller negative torque at the other side with the friction loss and the load loss can reduce the negative energy of the present invention. Therefore, the present invention can keep running, continuously impel and cast the single directional cast arms, self-operate under the action of gravity. After being cast, the single directional swing arm 13, under the action of gravity, continuously descends from high to low, so as to make the connected transmitting member 12 continuously operate too, thus converting the gravity potential energy into the kinetic energy.

At this moment, since one end of the connecting shaft 21 of the power generation unit 20 is connected with the wheel member 11 of the gravity energy conversion unit 10, and the connecting shaft 21 is driven by the wheel members 11, the connecting shaft 21 of the present invention transmits the rotational energy to the generator 24 successively through the fly wheel 22 and the gear box 23 and allows the generator 24 to rotate to generate electricity, and then transmit the electric energy out.

The force calculation analysis of the above operation in accordance with the present invention is referred to the following symbols:

T1: the output driving torque of the gravity power generation mechanism;

T2: the negative torque caused by the rotation of the generator 24;

ω2: the required rated angular speed of the generator 24;

T₁′: the output driving torque of the gear box 23;

M: the mass of the gravity member 134;

N: the quantity of the single directional swing arms 13;

$$\frac{{N}_{2}}{{N}_{1}} \text{:}$$

the gear ratio of the gear box 23;

V: the falling velocity of the gravity member 134 of the single directional swing arm 13;

L: the total length of the single swing arm 13;

R: the radius of the wheel member 11;

r: the radius of the gravity member 134;

the calculation formulas are obtained as follows:

negative torque=NM(R+r);

positive torque=NM(R+L+r)=NM(R+r)+NML;

The output driving torque of the gravity power generation mechanism(T1)=the positive torque−the negative torque=NML;

Being converted into the output driving torque of the gear box 23:

$${T}_{1}^{′} = T 1 \times \frac{{N}_{2}}{{N}_{1}} ;$$

Being equivalent to the output angular speed of the fly wheel 22:

$$ω 1 = ω 2 \times \frac{{N}_{2}}{{N}_{1}}$$

The falling velocity of the gravity member 134:

$$V = R ω 1 = R ω 2 \times \frac{{N}_{2}}{{N}_{1}}$$

When the relation: T₁′>T₂ is satisfied, the whole gravity power generation mechanism can drive the generator to operate. When the speed of the gravity members 134 of the single directional swing arms 13 is stable, the generator 24 can generate the rated capacity output.

With the above technology, the present invention not only has the advantages: more simplified in structure, higher conversion ratio, more environment-friendly, but also the single swing arms 13 only need a little of starting energy to carry out the energy output for a long time. Therefore, the present invention is more stable than the wind power generation and solar power generation systems and can be placed at an arbitrary position without being affected by the outside environment. The present invention is really a quite stable and effective energy conversion mechanism.

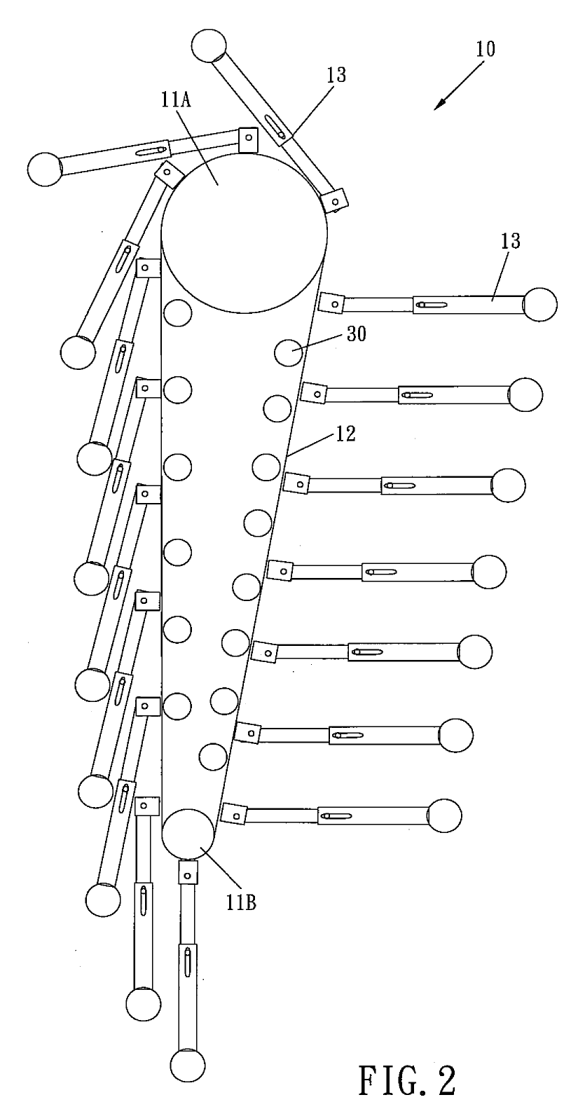

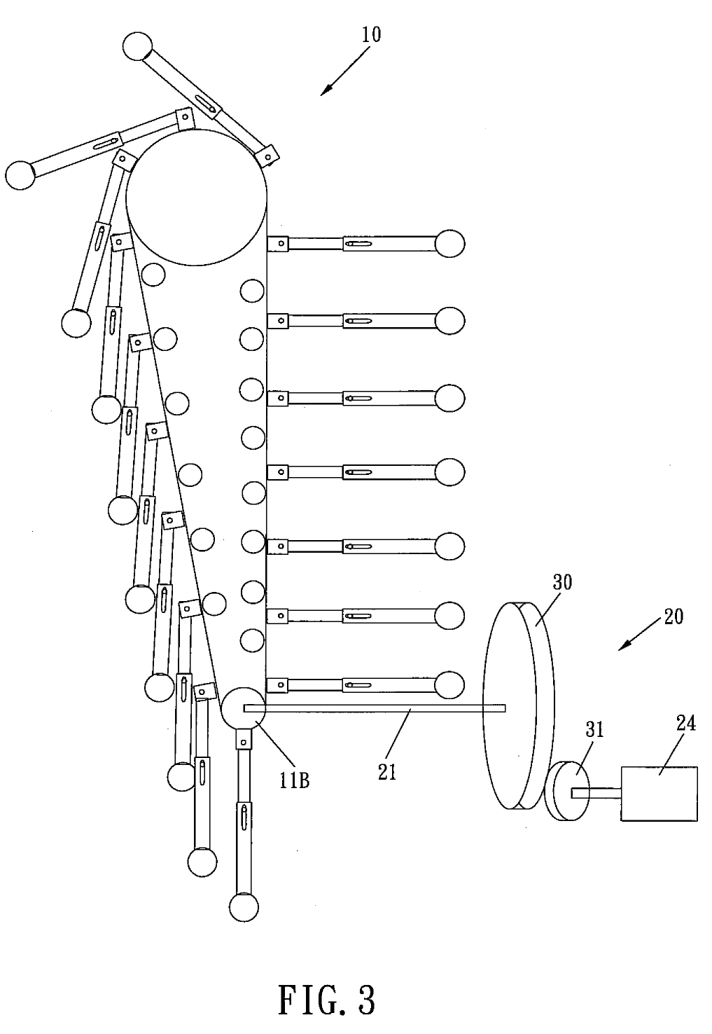

FIGS. 2-3 show a gravity power generation mechanism in accordance with a second embodiment of the present invention in which the same structures will not be described except the improved design.

The gravity energy conversion unit 10 includes a larger wheel member 11A, a smaller wheel member 11B. Inside the transmitting member 12 which is used together with the larger wheel member 11A and the smaller wheel member 11B is installed an assistant wheel 30. The gravity energy conversion unit 10 is sequentially disposed with, from the top down, the larger wheel member 11A, the smaller wheel member 11B along the direction of gravity, so that the outwards-casting action of the single directional swing arms 13 will produce a much larger positive torque by using the larger diameter of the larger wheel member 11A, after the respective single directional swing arms 13 rise to the top end.

In addition, the power generating unit 20 includes a connecting shaft 21, a larger gear 31, a smaller gear 32 and a generator 24. One end of the connecting shaft 21 is connected to the wheel member 11B of the gravity energy conversion unit 10, and the connecting shaft 21 is driven by the wheel member 11B. The connecting shaft 21 transmits the rotational kinetic energy to the generator 24 through the larger gear 31 and the smaller gear 32. At this moment, the generator 24 starts to rotate to generate electricity. The abovementioned is the characters of the structure and the features of the configuration in accordance with the second embodiment of the present invention.

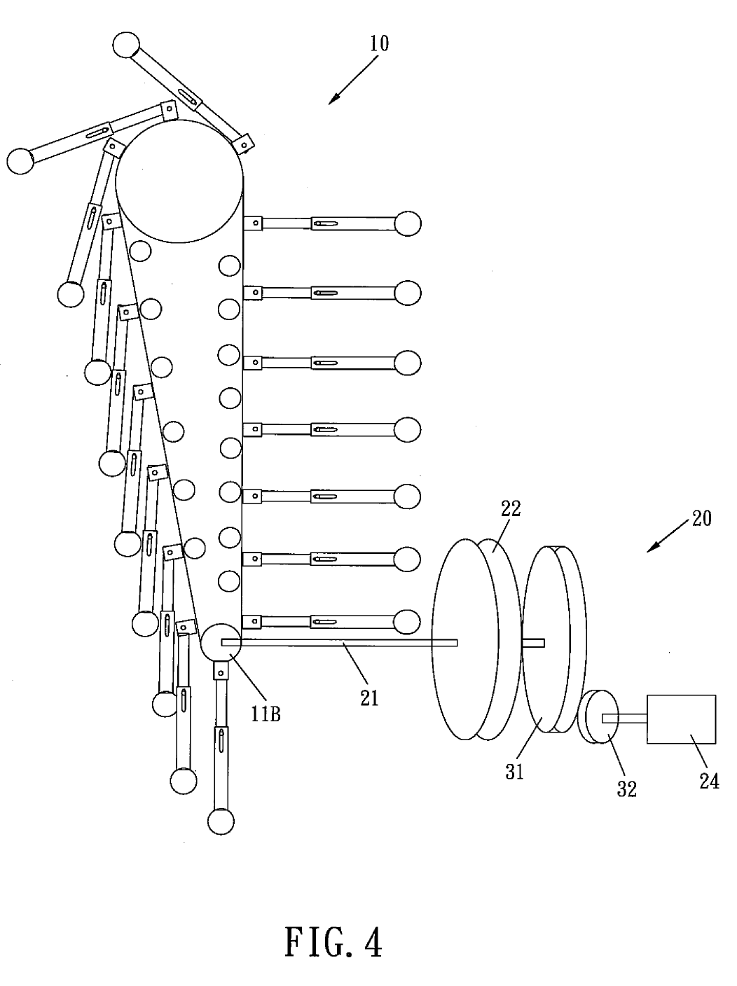

FIG. 4 shows a gravity power generation mechanism in accordance with the third embodiment of the present invention in which the power generating unit 20 includes a connecting shaft 21, a fly wheel 22, a larger gear 31, a smaller gear 32 and a generator 24. One end of the connecting shaft 21 is connected to the wheel member 11B of the gravity energy conversion unit 10, and the connecting shaft 21 is driven by the wheel member 11B. The connecting shaft 21 transmits the rotational kinetic energy to the generator 24 through the larger gear 31 and the smaller gear 32. At the this moment, a fly wheel 22 which can enhance the inertial force is installed to allow the generator 24 to rotate to generate electricity at a much more stable rotational speed, thus generating more stable rated voltage and frequency. The above-mentioned is the characters of the structure and the features of the configuration in accordance with the third embodiment of the present invention.

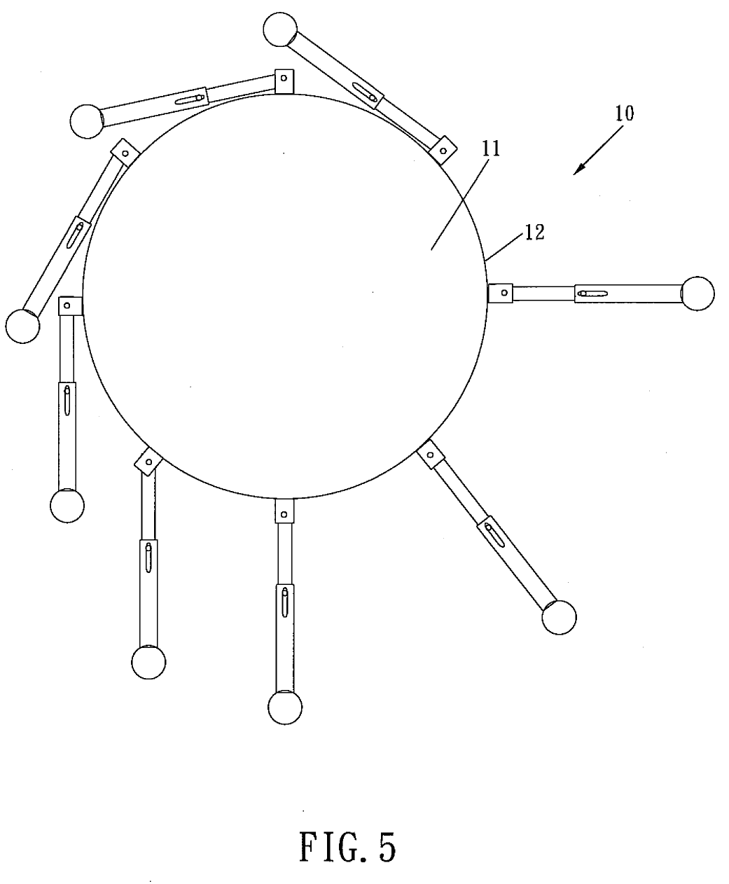

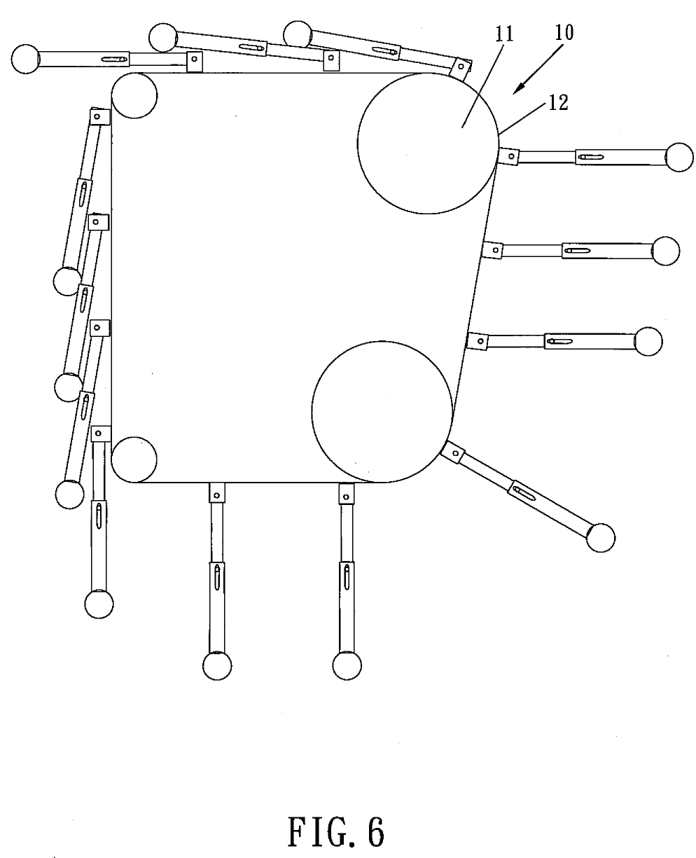

As for FIGS. 5 and 6, they show the fourth and the fifth embodiments of the present invention which represent the designs that the wheel members 11 and the transmitting member 12 of the gravity energy conversion unit 10 are positioned correspondingly to the direction of gravity. They may be the round-like mode as shown in FIG. 5 or the rectangle-like mode as shown in FIG. 6. However, the present invention is not only limited to the running path configurations as shown in the respective figures of the present invention. Elliptic, triangular, and polygonal paths, for instance, are also within the scope of the present invention.

To summarize, the gravity power generation mechanism of the present invention can utilize the gravity energy conversion unit to perform the effective energy conversion. The gravity energy conversion unit produces positive torques and by using the outwards-spreading single directional swing arms and reduces the negative torques by cooperating with the folding action of the single directional swing arms, so as to produce the long-time, effective and continuous energy conversion of converting the potential energy into the kinetic energy. And then the kinetic energy will be transmitted to a power generating unit to perform another energy conversion of converting the kinetic energy into the electric energy. And finally, the power supply system is used to transmit the electric energy out.

Hence, the present invention not only has the advantages, such as more simplified in structure, higher conversion ratio and more environment-friendly, but only needs a little of starting energy to carry out the energy output for a certain time. The present invention is more stable than the wind power generation system and the solar power generation system and can be placed at an arbitrary position without being affected by the outside environment. The present invention not only can independently generate electricity but can be parallel connected to the wind power generation system and the solar power generation system to generate electricity.

While we have shown and described various embodiments in accordance with the present invention, it is clear to those skilled in the art that further embodiments may be made without departing from the scope of the present invention.

What is claimed is:

1. A gravity power generation mechanism comprising:
a gravity energy conversion unit including a transmitting member, the transmitting member circulating correspondingly to a direction of gravity and being installed with a plurality of single directional swing arms outside thereof, the gravity energy conversion unit producing a larger positive torque by casting the single directional arms outwards and producing a smaller negative torque by cooperating with an inward-folding action of the single directional swing arm, so as to continuously cast the single directional arms by means of gravity, after being cast, the single directional swing arm, under the action of gravity, continuously descends from high to low, so as to make the connected transmitting member continuously operate too, thus converting gravity potential energy into kinetic energy and then transmit the kinetic energy out to perform an energy conversion power generation.

2. The gravity power generation mechanism as claimed in claim 1 further comprising a power generating unit, the power generating unit including a generator which is driven by the transmitting member of the gravity energy conversion unit, and the power generating unit converting energy to generate electricity by use of the generator.

3. The gravity power generation mechanism as claimed in claim 2, wherein the gravity energy conversion unit includes:
at least two wheel members which are pivotally disposed along the direction of gravity;
at least one transmitting member which is installed on the wheel members; and
a plurality of single directional swing arms which are positioned outside the transmitting member by single directional pivot seats, and the single directional pivot seats only allow the respective single directional arms to pivotally rotate in opposite direction of the transmitting member.

4. The gravity power generation mechanism as claimed in claim 3, wherein the single directional swing arms are equidistantly positioned outside the transmitting member by use of the single directional pivot seats.

5. The gravity power generation mechanism as claimed in claim 3, wherein the respective single directional swing arms is installed with a gravity member, each single directional swing arm includes at least one swing rod and a pivot rod that are pivotally coupled to each other, an outer end of the swing rod is disposed with the gravity member, and the other end of the swing rod utilizes an axial elongated pivot hole thereof to restrict a pivot pin of the pivot rod, the pivot rod is pivotally coupled to and restricted by the single directional pivot seat, and the swing rod and the pivot rod have a predetermined extension distance therebetween to generate an extension inertial force.

6. The gravity power generation mechanism as claimed in claim 3, wherein the single directional pivot seats only allow the respective single directional swing arms to be pivotally folded 90 degrees in opposite direction of the transmitting member, and the respective single directional swing arms freely rotate within a horizontal and vertical angle with respect to the transmitting member.

7. A gravity power generation mechanism comprising:
a gravity energy conversion unit including a transmitting member, the transmitting member utilizing a plurality of wheel members to circulate correspondingly to a direction of gravity, the transmitting member being installed with a plurality of single directional swing arms outside thereof, the gravity energy conversion unit produces a larger positive torque by casting the single directional arms outwards and produces a smaller negative torque by cooperating with an inward-folding action of the single directional swing arms, so as to make the transmitting member continuously self-generate energy; and
a power generating unit including a connecting shaft and a generator, one end of the connecting shaft being connected to the wheel members of the gravity energy conversion unit and driven by the wheel members, the connecting shaft transmits rotational kinetic energy to the generator, at this moment, the generator rotates to generate electricity.

8. The gravity power generation mechanism as claimed in claim 7, wherein the gravity energy conversion unit includes two wheel members, a transmitting member and a plurality of single directional swing arms, the two wheel members are pivotally disposed along the direction of gravity and the transmitting member is mounted on the two wheel members, the transmitting member and the two wheel members are drivingly linked to each other, the single directional swing arms utilize single directional pivot seats to be equidistantly positioned outside the transmitting member, and the single directional pivot seats only allow the respective single directional swing arms to pivotally rotate in opposite direction of the transmitting member, each single directional swing arm includes at least one swing rod and a pivot rod that are pivotally coupled to each other, an outer end of the swing rod is disposed with a gravity member, and the other end of the swing rod uses an axial elongated pivot hole thereof for restricting a pivot pin of the pivot rod, and the pivot rod is pivotally coupled to and restricted by the single directional pivot seat to generate an extension inertial force;
the power generating unit includes a connecting shaft, a fly wheel and a generator, the connecting shaft is installed with an universal joint, and one end of the connecting shaft is connected to the wheel members of the gravity energy conversion unit and driven by the wheel members, the connecting shaft transmits rotational kinetic energy to the generator after using the fly wheel to enhance inertial force.

9. The gravity power generation mechanism as claimed in claim 7, wherein a configuration path of the wheel members and the transmitting member of the gravity energy conversion unit is allowed to be similar to a round shape, an elliptic shape, a rectangular shape or a triangular shape and is designed correspondingly to the direction of gravity.

10. The gravity power generation mechanism as claimed in claim 7, wherein the transmitting member and the wheel members of the gravity energy conversion unit are designed as a cooperation of a chain and chain wheels, a cooperation of a belt and pulleys or a cooperation of a wheel rail belt and driving delivery wheels.

11. The gravity power generation mechanism as claimed in claim 7, wherein a gear box is installed in the power generating unit, and the connecting shaft transmits kinetic energy to the generator through the gear box.

12. The gravity power generation mechanism as claimed in claim 7, wherein a larger gear wheel, a smaller gear are installed in the power generating unit, and the connecting shaft transmits kinetic energy to the generator through the larger gear and the smaller gear.

13. The gravity power generation mechanism as claimed in claim 8, wherein the power generating unit is parallel connected to at least one mechanical structure to increase the positive torque required by power generation.
